(19) United States
(12) Patent Application Publication
(10) Pub. No.: US 2009/0100433 A1
(43) Pub. Date: Apr. 16, 2009

(54) DISK SCHEDULING METHOD AND APPARATUS

(75) Inventors: Dongwook Kang, Daejeon (KR); Jaemyoung Kim, Daejeon (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon-city (KR)

(21) Appl. No.: 12/121,574

(22) Filed: May 15, 2008

(30) Foreign Application Priority Data
Oct. 12, 2007 (KR) 10-2007-0103073

(51) Int. Cl. G06F 9/46; G06F 3/06

(52) U.S. Cl. 718/103; 710/6

(57) ABSTRACT

The present invention relates to a method and apparatus for scheduling requests having priorities and deadlines for an I/O operation on a disk storage medium. Requests are normally arranged and processed in deadline order, and requests whose process times based on deadlines overlap each other are processed in priority order. Therefore, it is possible to prevent processing of any requests having relatively higher priorities from being delayed due to a process based on deadline order. Further, in order to minimize seek time, the requests may also be processed in the scanning order. Furthermore, in order to minimize a time required for performing request search and arrangement in the scanning order and the deadline order, a deadline queue where requests are arranged in deadline order and a scan order queue where requests are arranged in the scanning order may be separately prepared.

### BACKGROUND OF THE INVENTION

1. Field of the Invention

The present invention relates to a technique of processing data requests for a storage medium, and more particularly, to a method and apparatus for scheduling requests for input and output operations on a disk storage medium.

The invention was supported by the IT R&D program of MIC/IITA. [2006-S038-02, Development of Device-Adaptive Embedded Operating System for Mobile Convergence Computing]

2. Description of the Related Art

Disk scheduling algorithms may be implemented, for example, in general-purpose operating system software or drive firmware. A disk scheduling algorithm may reorder data requests to a storage medium, for example, a hard disk, a floppy disk, and a CD, scheduled to be accessed by a computer, to minimize seek time of a disk head, thereby maximizing a data processing rate. Data requests are, for example, input/output (hereinafter, simply referred to as I/O) requests for writing data on a disk or reading data from a disk. Seek time is a period of time for a disk head to move from a current track position to a requested track position.

Referring to FIG. 1, when requests R1 to R5 are issued in time order in order to minimize seek time of a disk head 17 on a disk 15, a general disk scheduling algorithm reorders the requests R1 to R5 in a direction A in which the disk head 17 moves across tracks and inserts the reordered requests into a scan order queue Q. Therefore, the requests are processed in the scanning order, i.e., in the order of R3, R1, R4, R2, and R5. An elevator algorithm (or SCAN) or a circular elevator algorithm (or C-SCAN) is a representative disk scheduling algorithm based on seek time.

A disk scheduling algorithm based on seek time processes I/O requests to a disk in the scanning order in a direction in which a disk head moves across tracks. Therefore, resource starvation may occur in a request for a specific sector of a track that is far from the current position of the disk head in the direction in which the disk head moves across tracks.

In order to solve this problem, U.S. Pat. No. 6,496,899 discloses a disk scheduler that restricts the number of data requests capable of being inserted into a scan order queue during each traversal of a disk head across a disk, thereby preventing resource starvation from occurring in a specific request.

U.S. Pat. No. 6,078,998 discloses another disk scheduler. When a new request is inserted in a request queue and the deadline of any one of the existing requests is thus not ensured, the disk scheduler moves one of the existing requests before the new request with the lowest priority to the end of the request queue, thereby ensuring the deadlines of the requests.

A deadline of a request is a time before which the request must start to be processed. For example, deadlines of a reading request and a writing request to a disk may be set to 500 ms and 5 sec, respectively. Disk I/O requests generally have priorities according to their importance. For example, in case of requests for multimedia transmission, higher-priced transmission requests may have relatively higher priorities than lower-priced transmission, or audio data requests may have relatively higher priorities than video data requests.

U.S. Pat. No. 7,206,866 discloses another disk scheduler which transmits a fixed number of requests from two queues to a scan order queue, thereby restricting a standby time period for the requests and providing an allowable process rate. The two queues include a periodic queue where periodic disk requests are arranged and an a periodic queue where a periodic disk requests are arranged, and the fixed number of requests is selected in a fixed ratio from the periodic queue and the a periodic queue.

The disk scheduler disclosed in U.S. Pat. No. 6,496,899 is capable of maximizing fairness among requests by uniformizing the process times for the requests. However, this may not meet the deadline or priority of a specific request.

The disk scheduler disclosed in U.S. Pat. No. 6,078,988 continues to move requests of a request queue to the end of the request queue when the deadlines of the requests are not ensured due to a new request inserted into the request queue. Therefore, resource starvation may occur in a specific request. Further, the disk scheduler disclosed in U.S. Pat. No. 6,078,988 uses a single request queue. Therefore, a large amount of overhead may occur in searching for requests whose deadlines are not ensured whenever a new request is inserted.

Similar to that disclosed in U.S. Pat. No. 6,496,899, the disk scheduler disclosed in U.S. Pat. No. 7,206,866 is capable of maximizing fairness among requests. However, when requests concentrate on a queue having a relatively low service ratio, for example, a queue where a periodic disk requests are arranged, resource starvation may occur in a specific request of the queue.

Other disk scheduling techniques according to the related art do not propose any efficient solutions capable of processing a case when deadlines of requests are close to each other. In the disk scheduling techniques according to the related art, when deadlines of requests are close to each other, some of the requests may not be immediately processed, but processing thereof may be delayed even though their deadlines have passed. Specifically, requests having relatively higher priorities may be processed later than requests having relatively lower priorities.

For example, when processing requests R1 to R4 arranged in a request queue Q in deadline order as shown in FIGS. 2 and 3, a disk scheduler according to the related art sequentially processes the requests R1, R2, and R3 whose deadlines are close to each other (it is assumed that the same process time unit of 10 is used). Therefore, processing of the request R3 having the highest priority is delayed and then performed after its deadline has elapsed.

### SUMMARY OF THE INVENTION

Accordingly, it is an object of the present invention to provide a method and apparatus capable of efficiently scheduling requests whose deadlines are close to each other.

It is another object of the present invention to provide a disk scheduling method and apparatus for processing requests in priority order whose deadlines are close to each other, thereby efficiently meeting both the deadlines and priorities.

It is still another object of the present invention to provide a disk scheduling method and apparatus for processing requests in priority order whose deadlines are close to each other, thereby preventing processing of any requests having relatively higher priorities from being delayed due to a process based on deadline order.

It is yet another object of the present invention to provide a disk scheduling method and apparatus for inserting requests into both a scan order queue and a deadline queue and performing a request ordering, thereby minimizing the time required for a scan order search and a deadline search.

According to an aspect of the present invention, there is provided a method of scheduling requests having priorities and deadlines for an input/output operation on a disk storage medium. The method includes: arranging requests in priority order whose process times based on deadlines overlap each other; and processing the arranged requests in priority order.

According to another aspect of the present invention, there is provided a method of scheduling requests having priorities and deadlines for an I/O operation on a disk storage medium. The method includes: arranging the requests in deadline order wherein any requests whose process times based on deadlines overlap each other are arranged in priority order; and processing the arranged requests in the order in which the requests are arranged.

The arranging of the requests may include: classifying the requests whose process times overlap each other as a first request group; if the process time of the first request group overlaps the process time of another request or another request group, putting another request or another request group in the first request group; and arranging the requests of the first request group in priority order.

Therefore, according to the above-mentioned aspects, the requests whose deadlines are close to each other may be processed in priority order, thereby preventing processing of any requests having relatively higher priorities from being delayed due to a process based on deadline order.

The processing of the arranged requests may include: if no requests reaching their deadlines or having missed their deadlines exist at a current time point, processing the requests in the scanning order on the disk storage medium. According to this structure, normal processing of requests is performed in the scanning order, and any requests reaching their deadlines or having missed deadlines during the normal processing are preferentially processed, which makes it possible to minimize the seek time and process requests in consideration of deadline order.

Further, the arranging of the requests may include arranging the requests in a deadline queue and arranging the requests in a scan order queue in the scanning order on the disk storage medium. The processing of the arranged requests may includes: if no requests reach their deadlines or have missed their deadlines at a current time point, processing requests from the scan order queue in the scanning order; and if any requests reach their deadlines or have missed their deadlines at the current time point, processing the requests in the order in which the requests are arranged in the deadline queue. Therefore, according to this structure, requests are inserted and arranged in the deadline queue in deadline order and simultaneously, are inserted and arranged in the scan order queue in the scanning order, thereby reducing the time required by a single request queue for searching/reordering the requests in the scanning order and the deadline order.

According to still another aspect of the present invention, a disk scheduling apparatus includes a request ordering unit and a request processor that execute the above-mentioned disk scheduling methods.

### BRIEF DESCRIPTION OF THE DRAWINGS

FIG. 1 is a diagram illustrating the concept of a conventional disk scheduling algorithm based on seek time;

FIG. 2 is a schematic diagram illustrating the arrangement of requests in a request queue in deadline order;

FIG. 3 is a diagram illustrating processing of requests in deadline order over time;

FIG. 4 is a diagram illustrating the configuration of a disk scheduling apparatus according to a first embodiment of the present invention;

FIG. 5 is a conceptual diagram illustrating the generation of a request group according to the first embodiment of the present invention;

FIG. 6 is a diagram illustrating processing of requests over time according to the first embodiment of the present invention;

FIG. 7A is a diagram illustrating reordering when a process time of a new request overlaps a process time of an existing request according to the first embodiment of the present invention;

FIG. 7B is a diagram illustrating reordering when a process time of a new request overlaps a process time of an existing request group according to the first embodiment of the present invention;

FIG. 8 is a flowchart illustrating a disk scheduling method according to the first embodiment of the present invention;

FIG. 9 is a diagram illustrating the configuration of a disk scheduling apparatus according to a second embodiment of the present invention; and

FIG. 10 is a diagram illustrating the configuration of a disk scheduling apparatus according to a third embodiment of the present invention.

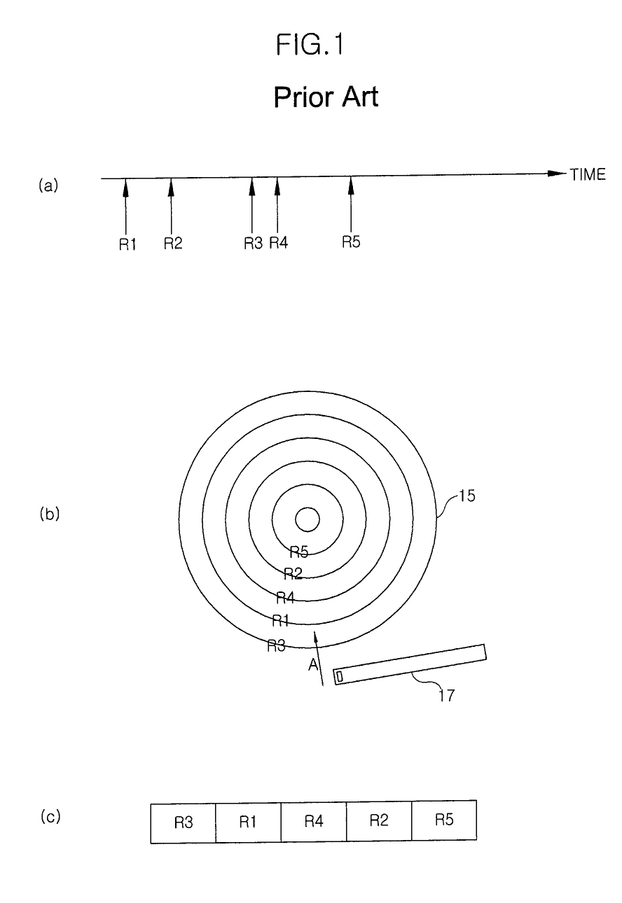

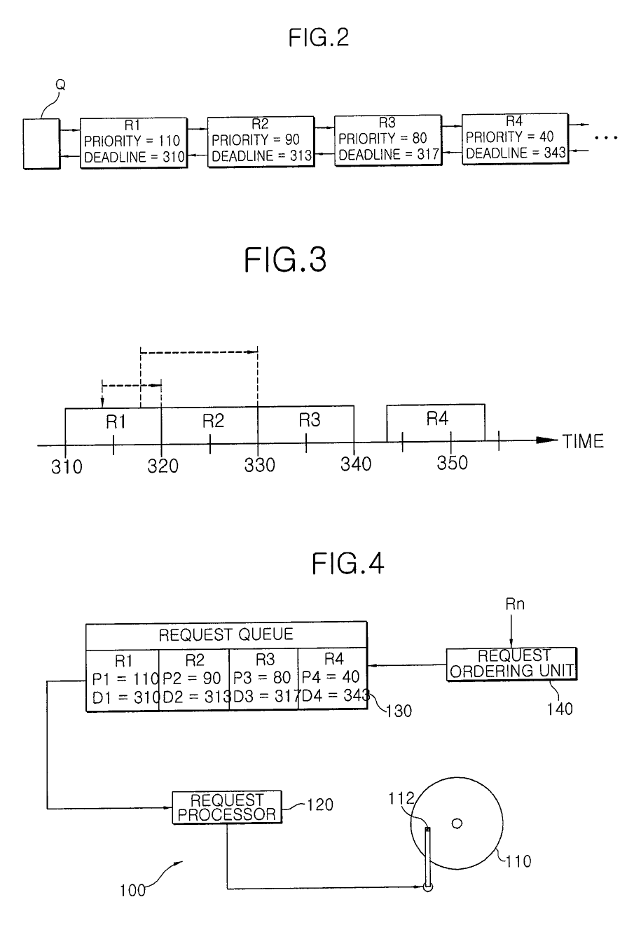

### DESCRIPTION OF THE PREFERRED EMBODIMENTS

Embodiments of the present invention will now be described with reference to the appending drawings.

### First Embodiment

FIG. 4 shows the configuration of a disk scheduling apparatus 100 according to this embodiment. The disk scheduling apparatus 100 includes a request processor 120 that provides commands required to position a disk head 112 for a reading/writing operation on a disk 110, a request queue 130 where requests are arranged to be processed by the request processor 120, and a request ordering unit 140 that orders input requests and inserts the input requests into the request queue 130. Requests R1 to Rn are associated with information on deadlines D1 to Dn, priorities P1 to Pn, and access positions on the disk 110. The smaller number represents the higher priority.

In this embodiment, the request ordering unit 140 orders input requests in deadline order and inserts the input requests into the request queue 130. The request processor 120 processes the requests from the lead request R1 of the request queue 130 sequentially. When a new request is input, the request ordering unit 140 inserts the new request in an appropriate position of the request queue on the basis of the deadline of the new request.

If it is assumed that process time units of individual requests are 10 as shown in FIG. 3, the deadlines of the requests R2 and R3 are within the process time period of the request R1. Therefore, the deadlines of the requests R2 and R3 are not met. Specifically, even though the request R3 has the higher priority than the requests R1 and R2, the process time of the request R3 is delayed. In order to solve this problem, the disk scheduling apparatus 100 according to this embodiment groups a request together with requests whose deadlines are within the process time period of the request, and processes the requests of the group in priority order.

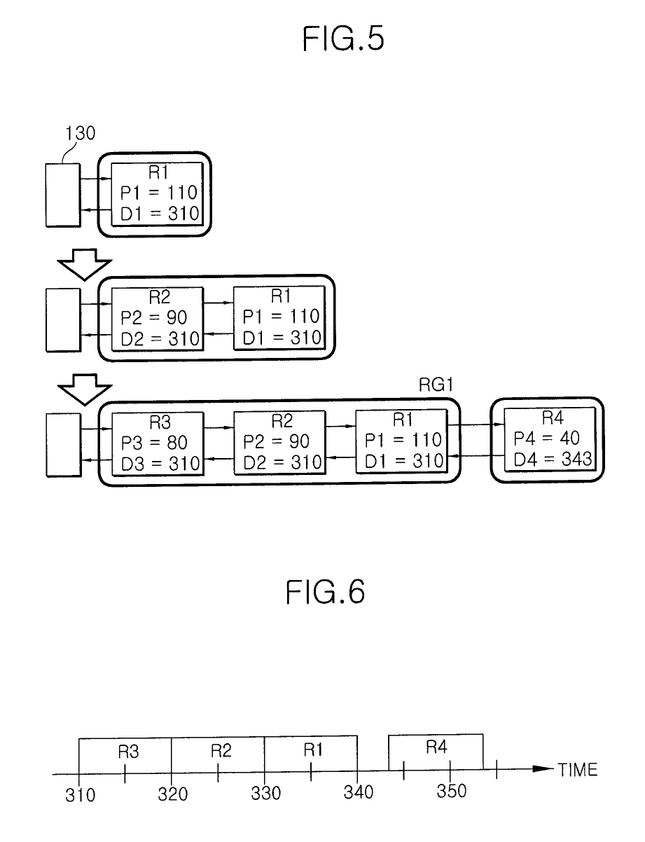

That is, the request ordering unit 140 classifies the requests R1, R2, and R3, close to each other, as a request group RG1, and reorders the requests of the request group RG1 in priority order, as shown in FIG. 5. The deadline of the request group RG1 is set to the earliest one (‘310’ in this embodiment) among the deadlines of the requests in the request group such that the request group RG1 has a single deadline. Request R4 whose deadline is after the process time of the request group RG1 (‘30’ in this embodiment) form another request group together with other following requests. Therefore, the requests R1, R2, R3, and R4 are processed by the request processor 120 in the order as shown in FIG. 6.

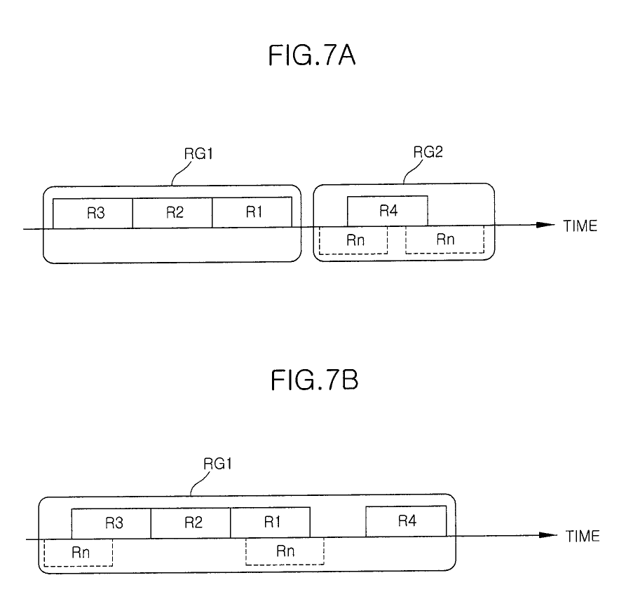

If a new request Rn is input, the request ordering unit 140 inserts the new request Rn in an appropriate position of the request queue 130 on the basis of the deadline of the new request. In this case, as shown in FIG. 7A, if the process time of the new request Rn does not overlap the process time of the request group RG1 but overlaps the process time of the request R4, the requests R4 and Rn form a new request group RG2. The request ordering unit 140 reorders the requests R4 and Rn in priority order, and the deadline of the request group RG2 is set to the earliest one of the deadlines of the requests R4 and Rn.

As shown in FIG. 7B, if the process time of the request Rn overlaps the process time of the request group RG1, the request Rn is put in the request group RG1 and the request ordering unit 140 reorders the requests Rn, R1, R2, and R3 in priority order. In this case, the process time of the request group RG1 increases up to ‘40’, and thus overlap the process time of the request R4. Therefore, the request R4 is also put in the request group RG1. Consequently, in the case shown in FIG. 7B, all the requests R1, R2, R3, R4, and Rn belong to the request group RG1. Then, the request ordering unit 140 reorders the requests R1, R2, R3, R4, and Rn in priority order, and accordingly, the deadline of the request group RG1 is reset.

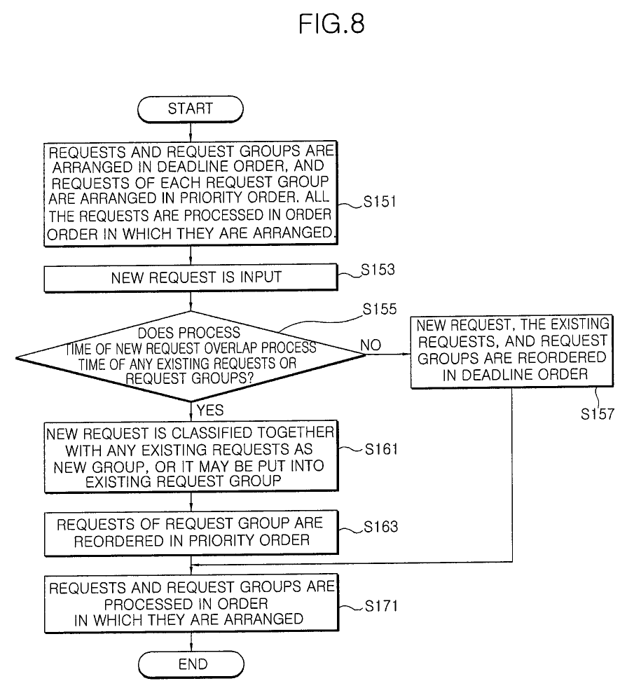

The operation of the disk scheduling apparatus 100 according to this embodiment will be described below in detail with reference to FIG. 8.

Initially, requests and request groups are arranged in the request queue 130 in deadline order, requests of each request group are arranged in priority order, and all the requests are processed in the order in which they are arranged (S151).

When a user inputs a new disk I/O request (S153), the request ordering unit 140 determines whether the process time of the new request overlaps the process time of any existing requests or request groups (S155). If the determination result is ‘No’, the request ordering unit 140 reorders the new request together with the existing requests and request groups in deadline order (S157).

If the determination result in Step S155 is ‘Yes’, the request ordering unit 140 may classify the new request together with any existing requests as a new group, as shown in FIG. 7A, or it may put the new request into the existing request group, as shown in FIG. 7B (S161). Then, the request ordering unit 140 reorders the requests of the request group in priority order (S163).

The request processor 120 processes the requests and request groups in order of arrangement (S171). That is, the request processor 120 processes the requests and request groups in deadline order and processes the requests of each request group in priority order.

According to this embodiment, requests whose deadlines are close to each other (whose process times overlap each other) are processed in priority order, thereby preventing processing of any requests having relatively higher priorities from being delayed due to a process based on deadline order.

### Second Embodiment

The second embodiment is different from the first embodiment in that requests are processed in the scanning order in a normal state and any requests reaching their deadlines during normal processing are preferentially processed. Meanwhile, this embodiment is similar to the first embodiment in that requests whose process times based on deadline order overlap each other are reordered and processed in priority order.

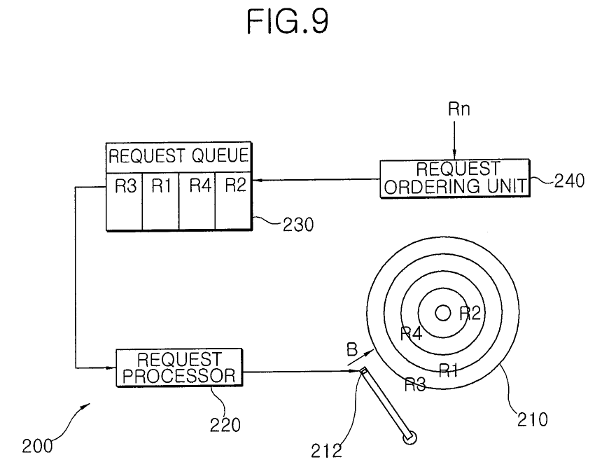

FIG. 9 shows a disk scheduling apparatus 200 according to this embodiment. Hereinafter, only the different portions of this embodiment from the first embodiment will be described and a description of portions similar to or same as the first embodiment will be omitted. A request ordering unit 240 orders requests R1 to R4 of a request queue 230 in the scanning order in a direction B in which a disk head 212 moves across tracks. Further, the request ordering unit 240 searches the request queue 230 to determine whether a request or request group reaching or having missed its deadline exists at a time point when any request is processed in the scanning order. If such a request or request group does not exist as the search result, the current arrangement state of the request queue 230 is maintained. If such a request or request group is searched, the request ordering unit 240 reorders the request queue 230 such that the searched request or request group can be preferentially processed.

In this case, the request ordering unit 240 reorders the requests or request groups of the request queue 230 in the same manner as that according to the first embodiment. Then, the request processor 220 processes the requests from the request queue 230 in the order in which the requests are arranged.

According to this embodiment, normal processing of requests is performed in the scanning order and any requests reaching or having missed deadlines during normal processing are preferentially processed. Therefore, it is possible to minimize the seek time and process requests in consideration of deadline order.

### Third Embodiment

The third embodiment has a characteristic that it uses a deadline queue 332 and a scan order queue 334, instead of the request queue 230. The other functions are the same as those in the second embodiment.

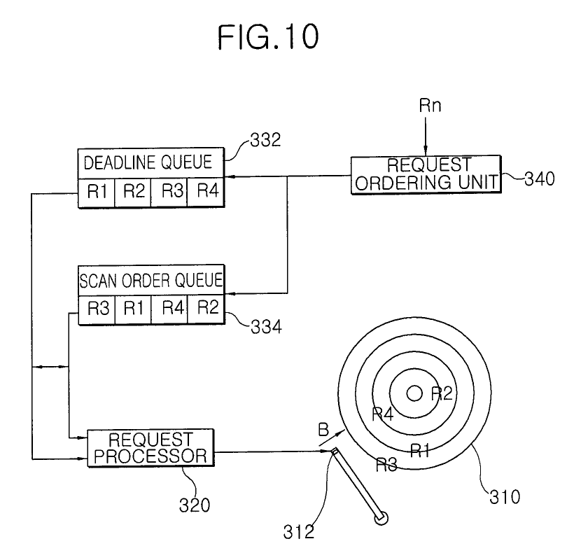

Referring to FIG. 10, input requests are simultaneously inserted into both the deadline queue 332 and the scan order queue 334. Then, a request ordering unit 340 orders the requests inserted into the deadline queue 332 in the same manner as that in the first embodiment. That is, the requests inserted into the deadline queue 332 are arranged in deadline order and any requests whose deadlines are close to each other (whose process times overlap each other) are arranged in priority order. Further, the request ordering unit 340 arranges the requests inserted into the scan order queue 334 in the scanning order.

A request processor 320 processes the requests from the scan order queue 334 unless any requests reaching their deadlines or having missed their deadlines exist. During this process, if any requests reaching their deadlines or having missed their deadlines are searched from the deadline queue 332, the request processor 320 processes the requests from the deadline queue 332. The requests processed by the request processor 320 are removed from both the deadline queue 332 and the scan order queue 334.

According to this embodiment, the requests of the deadline queue 332 and the scan order queue 334 are arranged in their own arrangement. Therefore, whenever a request is processed in the scanning order, the order of the deadlines of the requests is searched, thereby reducing the reordering time.

According to the present invention, since requests whose deadlines are close to each other (whose process times overlap each other) are processed in priority order, it is possible to prevent processing of any requests having relatively higher priorities from being delayed due to a process based on deadline order.

Further, requests are processed in the scanning order in a normal state, and when any requests reach their deadlines or they have missed deadlines during normal processing, the requests are preferentially processed. Therefore, it is possible to minimize the seek time and process requests in consideration of deadline order.

Furthermore, since requests are simultaneously inserted and arranged in the deadline queue and the scan order queue in the deadline order and the scanning order, respectively, it is possible to reduce a time required by a single request queue for searching/reordering the requests in the scanning order and the deadline order.

In the drawings and specification, there have been disclosed typical embodiments of the present invention and, although specific terms are employed, they are used in a generic and descriptive sense only and not for purposes of limitation. It will be apparent to those skilled in the art that modifications and variations can be made in the present invention without deviating from the spirit or scope of the invention. Thus, it is intended that the present invention cover any such modifications and variations of this invention provided they come within the scope of the appended claims and their equivalents.

What is claimed is:

1. A method of scheduling requests having priorities and deadlines for an input/output operation on a disk storage medium, the method comprising:
arranging requests in priority order whose process times based on deadlines overlap each other; and
processing the arranged requests in priority order.

2. The method of claim 1,
wherein the arranging of the requests includes:
classifying the requests whose process times overlap each other as a first request group;
if the process time of the first request group overlaps the process time of another request or another request group, putting another request or another request group in the first request group; and
arranging the requests of the first request group in priority order.

3. A method of scheduling requests having priorities and deadlines for an I/O operation on a disk storage medium, the method comprising:
arranging the requests in deadline order wherein any requests whose process times based on deadlines overlap each other are arranged in priority order; and
processing the arranged requests in the order in which the requests are arranged.

4. The method of claim 3,
wherein the arranging of the requests includes:
classifying the requests whose process times overlap each other as a first request group;
if the process time of the first request group overlaps the process time of another request or another request group, putting another request or another request group in the first request group; and
arranging the requests of the first request group in priority order.

5. The method of claim 3,
wherein the processing of the arranged requests includes:
if no requests reaching their deadlines or having missed their deadlines exist at a current time point, processing the requests in the scanning order on the disk storage medium.

6. The method of claim 4,
wherein the processing of the arranged requests includes:
if no requests reaching their deadlines or having missed their deadlines exist at a current time point, processing the requests in the scanning order on the disk storage medium.

7. The method of claim 3,
wherein the arranging of the requests includes:
arranging the requests in a deadline queue and arranging the requests in a scan order queue in the scanning order on the disk storage medium, and
the processing of the arranged requests includes:
if no requests reach their deadlines or have missed their deadlines at a current time point, processing requests from the scan order queue in the scanning order, and if any requests reach their deadlines or have missed their deadlines at the current time point, processing the requests in the order in which the requests are arranged in the deadline queue.

8. The method of claim 4,
wherein the arranging of the requests includes:
arranging the requests in a deadline queue and arranging the requests in a scan order queue in the scanning order on the disk storage medium, and
the processing of the arranged requests includes:
if no requests reach their deadlines or have missed their deadlines at a current time point, processing requests from the scan order queue in the scanning order, and if any requests reach their deadlines or have missed their deadlines at the current time point, processing the requests in the order in which the requests are arranged in the deadline queue.

9. An apparatus for scheduling requests having priorities and deadlines for an I/O operation on a disk storage medium, the apparatus comprising:
a request ordering unit that arranges the requests in deadline order wherein any requests whose process times based on deadlines overlap each other are arranged in priority order; and
a request processor that processes the requests in the order in which the requests are arranged.

10. The apparatus of claim 9,
wherein the request ordering unit classifies the requests whose process times overlap each other as a first request group, and
if the process time of the first request group overlaps the process time of another request or another request group, the request ordering unit puts another request or another request group in the first request group, and arranges the requests of the first request group in priority order.

11. The apparatus of claim 9,
wherein, if no requests reaching their deadlines or having missed their deadlines are exist at a current time point, the request processor processes the requests in the scanning order on the disk storage medium.

12. The apparatus of claim 10,
wherein, if no requests reaching their deadlines or having missed their deadlines are exist at a current time point, the request processor processes the requests in the scanning order on the disk storage medium.

13. The apparatus of claim 9,
wherein the request ordering unit arranges the requests in a deadline queue and arranges the requests in a scan order queue in the scanning order on the disk storage medium, and
if no requests reach their deadlines or have missed their deadlines at a current time point, the request processor processes requests from the scan order queue in the scanning order, and if any requests reach their deadlines or have missed their deadlines at the current time point, processes the requests in the order in which the requests are arranged in the deadline queue.

14. The apparatus of claim 10,
wherein the request ordering unit arranges the requests in a deadline queue and arranges the requests in a scan order queue in the scanning order on the disk storage medium, and
if no requests reach their deadlines or have missed their deadlines at a current time point, the request processor processes requests from the scan order queue in the scanning order, and if any requests reach their deadlines or have missed their deadlines at the current time point, processes the requests in the order in which the requests are arranged in the deadline queue.
